(19) United States
(12) Patent Application Publication
(10) Pub. No.: US 2026/0269758 A1
(43) Pub. Date: Sep. 10, 2026

(54) LINEAR CONVEYOR DEVICE AND METHOD FOR CONTROLLING LINEAR CONVEYOR DEVICE

(71) Applicant: YAMAHA HATSUDOKI KABUSHIKI KAISHA, Iwata-shi, Shizuoka (JP)

(72) Inventor: Shunsuke AOKI, Iwata-shi (JP)

(73) Assignee: YAMAHA HATSUDOKI KABUSHIKI KAISHA, Iwata-shi, Shizuoka (JP)

(21) Appl. No.: 19/471,311

(22) PCT Filed: Apr. 12, 2023
(86) PCT No.: PCT/JP2023/014861

§ 371 Date: Sep. 30, 2025

(51) Int. Cl. H02P 25/064; B65G 54/02; H02K 41/03

(52) U.S. Cl. CPC H02P 25/064; B65G 54/02; H02K 41/031

(57) ABSTRACT

A linear conveyor device includes a first control driver configured to, when both a first mover and a second mover are located above a first controlled coil to which that first control driver is connected, perform a propulsive force reduction control to control a current in the first controlled coil so as to reduce a propulsive force that the first controlled coil applies to the first mover and the second mover.

### CROSS-REFERENCE TO RELATED APPLICATION

This application is a National Stage of International Patent Application No. PCT/JP2023/014861, filed Apr. 12, 2023, the entire content of which is incorporated herein by reference.

### BACKGROUND

### Technical Field

The present disclosure relates to a linear conveyor device and a method for controlling a linear conveyor device, and more particularly, it relates to a linear conveyor device including sliders and a method for controlling the linear conveyor device.

### Background Art

Conventionally, a linear conveyor device including sliders is known. Such a linear conveyor device is disclosed in International Publication No. 2020/225862, for example.

International Publication No. 2020/225862 discloses a linear conveyor system (linear conveyor device) including a plurality of sliders each including a linear motor mover, a plurality of electromagnets as stators arranged along a predetermined direction, and a plurality of servo units that apply a propulsive force to the linear motor mover by controlling the current of the plurality of electromagnets. In this linear conveyor system, each of the plurality of servo units controls the current of some of the plurality of electromagnets.

### SUMMARY

Although not clearly described in International Publication No. 2020/225862, in a linear conveyor system as described in International Publication No. 2020/225862, a propulsive force intended for one of two linear motor movers is also applied to the other when the two linear motor movers are simultaneously located above electromagnets to be controlled by one servo unit. Therefore, a minimum pitch between sliders may be determined such that the two linear motor movers are not simultaneously located above the electromagnets to be controlled by one servo unit. Specifically, the minimum pitch between the sliders may be determined to prevent the two linear motor movers from approaching each other to a distance less than the length of the electromagnets to be controlled by one servo unit. In such a case, the minimum pitch between the sliders disadvantageously becomes relatively large, and thus it is desired to reduce the minimum pitch between the sliders.

Accordingly, the present disclosure provides a linear conveyor device in which a minimum pitch between sliders can be reduced and a method for controlling the linear conveyor device.

A linear conveyor device according to a first aspect of the present disclosure includes a first slider including a first mover, a second slider including a second mover, a stator including a plurality of coils arranged along a predetermined direction, and a plurality of control drivers each connected to a controlled coil among the plurality of coils to control a current in the controlled coil to which that control driver is connected to apply a propulsive force along the predetermined direction to the first mover and the second mover. A first control driver of the plurality of control drivers is configured to, when both the first mover and the second mover are located above a first controlled coil to which that first control driver is connected, perform a propulsive force reduction control to control a current in the first controlled coil so as to reduce the propulsive force that the first controlled coil applies to the first mover and the second mover.

In the linear conveyor device according to the first aspect of the present disclosure, as described above, the first control driver is configured to, when both the first mover and the second mover are located above the first controlled coil to which that first control driver is connected, perform the propulsive force reduction control to control the current in the first controlled coil so as to reduce the propulsive force that the first controlled coil applies to the first mover and the second mover. Accordingly, even when both the first mover and the second mover are located above the first controlled coil, the influence of the first controlled coil can be reduced, and thus the first mover and the second mover can approach each other to a distance less than the length of the first controlled coil. Consequently, a minimum pitch between the sliders (between the first slider and the second slider) can be reduced.

In the linear conveyor device according to the first aspect, the first control driver is preferably configured to, when both the first mover and the second mover are located above the first controlled coil, perform the propulsive force reduction control so as not to flow a current to the first controlled coil. Accordingly, even when both the first mover and the second mover are located above the first controlled coil, the influence of the first controlled coil can be easily reduced, and thus the minimum pitch between the sliders (between the first slider and the second slider) can be easily reduced.

In the linear conveyor device according to the first aspect, a second control driver connected to a second controlled coil adjacent to the first controlled coil is preferably configured to, when the first control driver performs the propulsive force reduction control, perform a control to increase a current in the second controlled coil so as to compensate for a reduction in the propulsive force of a controlled mover that is either the first mover or the second mover and is located above the second controlled coil, caused by the propulsive force reduction control. Accordingly, the reduction in the propulsive force caused by the propulsive force reduction control can be compensated for, and thus a decrease in the transport speeds of the first slider and the second slider can be reduced or prevented. Consequently, an increase in the transport time of the first slider and the second slider can be reduced or prevented.

In such a case, the second control driver is preferably configured to, when the first control driver performs the propulsive force reduction control, perform a control to increase the current in the second controlled coil so as to maintain the propulsive force by compensating for the reduction in the propulsive force of the controlled mover caused by the propulsive force reduction control. Accordingly, the reduction in the propulsive force caused by the propulsive force reduction control can be compensated for to maintain the propulsive force, and thus a decrease in the transport speeds of the first slider and the second slider can be easily reduced or prevented. Consequently, an increase in the transport time of the first slider and the second slider can be easily reduced or prevented.

In the configuration in which the reduction in the propulsive force is compensated for, the second control driver is preferably configured to perform a control to increase the current in the second controlled coil so as to compensate for the reduction in the propulsive force of the controlled mover caused by the propulsive force reduction control, based on an overlap amount between the controlled mover and the first controlled coil. Accordingly, the current in the second controlled coil can be increased based on the overlap amount between the controlled mover and the first controlled coil, which correlates with the reduction in the propulsive force caused by the propulsive force reduction control, and thus the reduction in the propulsive force caused by the propulsive force reduction control can be accurately compensated for.

In such a case, the second control driver is preferably configured to acquire a current command magnification for the second controlled coil based on the overlap amount, and perform a control to increase the current in the second controlled coil based on an acquired current command magnification for the second controlled coil so as to compensate for the reduction in the propulsive force of the controlled mover caused by the propulsive force reduction control. Accordingly, the current in the second controlled coil can be increased based on the current command magnification acquired based on the overlap amount, and thus the reduction in the propulsive force caused by the propulsive force reduction control can be easily and accurately compensated for.

The linear conveyor device according to the first aspect preferably further includes a position detector to detect positions of the first mover and the second mover, and the first control driver is preferably configured to perform the propulsive force reduction control when the position detector detects that both the first mover and the second mover are located above the first controlled coil. Accordingly, the propulsive force reduction control can be performed in a state in which the position detector reliably detects that both the first mover and the second mover are located above the first controlled coil.

In the linear conveyor device according to the first aspect, the controlled coil preferably includes one set or a plurality of sets of three-phase coils, and the first control driver is preferably configured to perform the propulsive force reduction control when both the first mover and the second mover are located above the first controlled coil including the one set or the plurality of sets of three-phase coils. Accordingly, when the controlled coil including the one set or the plurality of sets of three-phase coils, which tends to increase the minimum pitch between the sliders (between the first slider and the second slider) due to its large length, is used, the minimum pitch between the sliders can be effectively reduced.

In the linear conveyor device according to the first aspect, the controlled coil preferably includes one coil of a set of three-phase coils, and the first control driver is preferably configured to perform the propulsive force reduction control when both the first mover and the second mover are located above the first controlled coil including the one coil of the set of three-phase coils. Accordingly, when the controlled coil including the one coil of the set of three-phase coils, which tends to reduce the minimum pitch between the sliders (between the first slider and the second slider) due to its small length, is used, the minimum pitch between the sliders can be further reduced.

Also, a method for controlling a linear conveyor device according to a second aspect of the present disclosure is a method for controlling a linear conveyor device including a first slider including a first mover, a second slider including a second mover, a stator including a plurality of coils arranged along a predetermined direction, and includes controlling a current in the plurality of coils to apply a propulsive force along the predetermined direction to the first mover and the second mover, and performing a propulsive force reduction control to control a current in a predetermined controlled coil of the plurality of coils so as to reduce the propulsive force that the predetermined controlled coil applies to the first mover and the second mover when both the first mover and the second mover are located above the predetermined controlled coil.

As described above, the method for controlling a linear conveyor device according to the second aspect of the present disclosure includes performing the propulsive force reduction control to control the current in the predetermined controlled coil of the plurality of coils so as to reduce the propulsive force that the predetermined controlled coil applies to the first mover and the second mover when both the first mover and the second mover are located above the predetermined controlled coil. Accordingly, even when both the first mover and the second mover are located above the predetermined controlled coil, the influence of the predetermined controlled coil can be reduced, and thus the first mover and the second mover can approach each other to a distance less than the length of the predetermined controlled coil. Consequently, it is possible to provide the method for controlling the linear conveyor device in which a minimum pitch between the sliders (between the first slider and the second slider) can be reduced.

According to the present disclosure, as described above, it is possible to reduce the minimum pitch between the sliders.

### BRIEF DESCRIPTION OF THE DRAWINGS

FIG. 1 is a plan view schematically showing a linear conveyor device according to an embodiment of the present disclosure;

FIG. 2 is a sectional view schematically showing a conveyor and a slider of the linear conveyor device according to the embodiment of the present disclosure;

FIG. 3 is a schematic view showing the slider, coils, and control drivers of the linear conveyor device according to the embodiment of the present disclosure;

FIG. 4 is a schematic view for illustrating a control of sliders in the linear conveyor device according to the embodiment of the present disclosure;

FIG. 5 is a schematic view for illustrating the controlled operation of sliders of the linear conveyor device according to the embodiment of the present disclosure;

FIG. 6 is a flowchart for illustrating a control process related to the control of the sliders according to the embodiment of the present disclosure;

FIG. 7 is a flowchart for illustrating the details of a process operation in step S5 of FIG. 6; and

FIG. 8 is a schematic view for illustrating a control of sliders in a linear conveyor device according to a modified example of the embodiment of the present disclosure.

### DETAILED DESCRIPTION

An embodiment embodying the present disclosure is hereinafter described on the basis of the drawings.

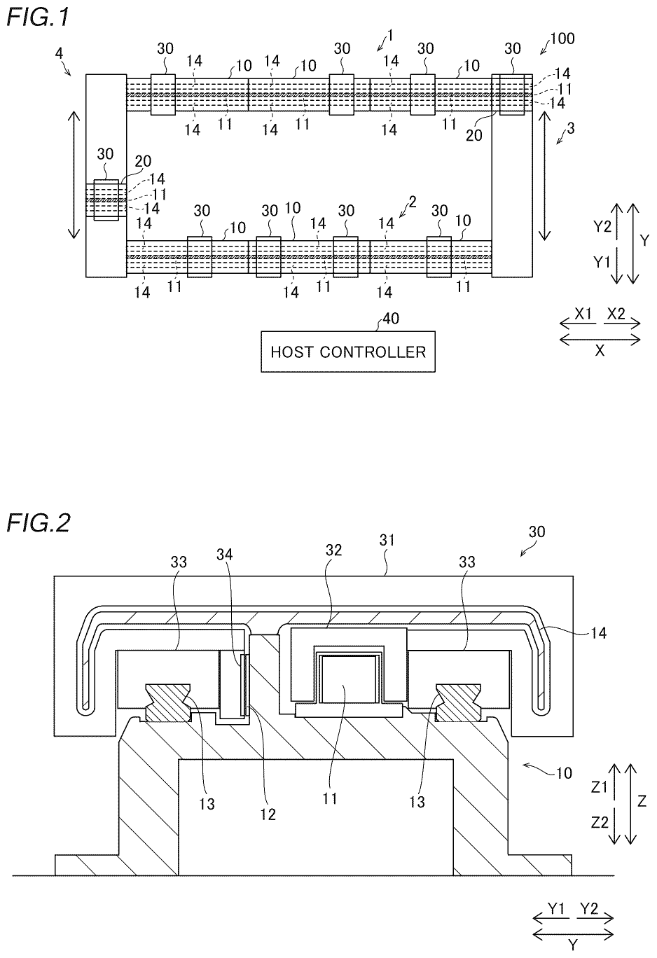

The structure of a linear conveyor device 100 according to the embodiment of the present disclosure is now described with reference to FIGS. 1 to 5.

### Configuration of Linear Conveyor Device

The linear conveyor device 100 according to this embodiment is configured to transport an object to be transported that is placed on a slider 30, along conveyors 1 and 2. Operations are performed on the object to be transported by the linear conveyor device 100 at a plurality of transport positions. Robots or operators perform the operations on the object to be transported.

As shown in FIG. 1, the linear conveyor device 100 includes the conveyor 1, the conveyor 2, a transfer conveyor 3, a transfer conveyor 4, and a slider 30. Furthermore, the linear conveyor device 100 includes a host controller 40.

The conveyor 1 includes a plurality of linear conveyor modules 10. The conveyor 2 includes a plurality of linear conveyor modules 10. The plurality of linear conveyor modules 10 are connected in series with each other to form a transport path for the slider 30. The slider 30 is transported in an X direction on the conveyors 1 and 2, and is transported in a Y direction from the conveyor 1 (2) to the conveyor 2 (1) by the transfer conveyors 3 and 4. That is, the slider 30 is transported cyclically between the conveyor 1, the transfer conveyor 3, the conveyor 2, and the transfer conveyor 4.

As shown in FIG. 2, the linear conveyor modules 10 each include a stator 11, magnetic sensors 12, guide rails 13, and a cover 14. The magnetic sensors 12 are examples of a “position detector” in the claims.

As shown in FIG. 1, the transfer conveyors 3 and 4 each include a transport mechanism 20 that transports the slider 30 in the X direction and a movement mechanism that moves the transport mechanism 20 in the Y direction. The transport mechanism 20 includes a stator 11 and a magnetic sensor 12. The movement mechanism includes guide rails and a ball screw mechanism.

As shown in FIG. 2, the slider 30 includes a slider main body 31, a mover 32, guide blocks 33, and a magnetic scale 34. A plurality of sliders 30 are provided. The plurality of sliders 30 move independently of each other on the conveyors 1 and 2 and the transfer conveyors 3 and 4.

The conveyors 1 and 2 are configured to move the slider 30 along the X direction. The conveyors 1 and 2 are provided substantially parallel to each other. The conveyor 1 transports the slider 30 in an X2 direction, and the conveyor 2 transports the slider 30 in an X1 direction. The conveyors 1 and 2 are fixed onto a platform. That is, the stators 11 and the guide rails 13 of the conveyors 1 and 2 are fixedly provided.

The transfer conveyor 3 is arranged adjacent on the X2 direction sides of the conveyors 1 and 2. The transfer conveyor 4 is arranged adjacent on the X1 direction sides of the conveyors 1 and 2.

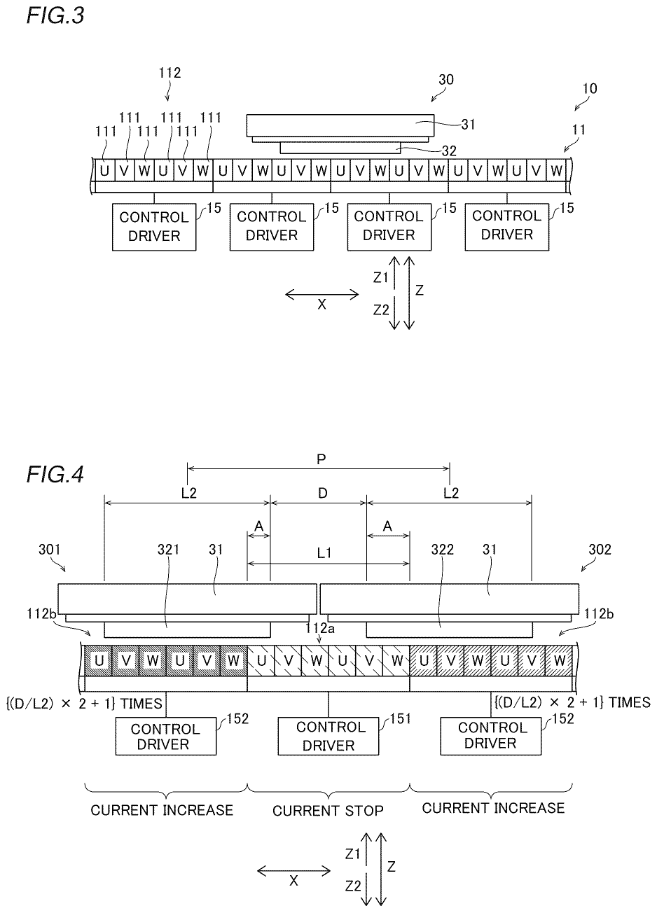

The stators 11 each include a plurality of coils 111 (see FIG. 3) including a plurality of sets of three-phase coils and arranged along the X direction. When a current is supplied to the plurality of coils 111, the slider 30 is moved. The stators 11 are arranged along the X direction.

The magnetic sensors 12 are configured to detect the magnetism of the magnetic scale 34. Specifically, the magnetic sensors 12 face the magnetic scale 34 of the slider 30 in the Y direction. The magnetic sensors 12 are configured to detect the magnetism of the magnetic scale 34 to detect the position of the mover 32 (slider 30). Furthermore, a plurality of magnetic sensors 12 are arranged at intervals along the X direction.

The guide rails 13 extend along the X direction. A pair of guide rails 13 are provided at an interval in the Y direction. The guide rails 13 are aligned between the linear conveyor modules 10 adjacent to each other in the X direction such that the slider 30 can be transferred therebetween. The guide blocks 33 of the sliders 30 engage with the guide rails 13 so as to be movable in the X direction.

The cover 14 is provided to cover upper portions of the stator 11, the magnetic sensors 12, and the guide rails 13. In other words, the cover 14 is provided to prevent the upper portions of the stator 11, the magnetic sensors 12, and the guide rails 13 from being exposed even when the slider 30 is not present.

The object to be transported is placed on the slider main body 31. The slider main body 31 is provided to surround the covers 14 of the conveyors 1 and 2 as viewed in the X direction. The mover 32, the guide blocks 33, and the magnetic scale 34 are attached to the slider main body 31.

The mover 32 interposes the stator 11 in the Y direction. The mover 32 includes a permanent magnet and a back yoke that holds the permanent magnet.

The guide blocks 33 are provided to be movable along the guide rails 13. The guide blocks 33 include a plurality of balls that move and circulate along the movement direction.

The magnetic scale 34 is provided on the slider 30 to extend along the X direction. The magnetic scale 34 is provided to detect the position of the mover 32 (slider 30).

The host controller 40 is configured to control each portion of the linear conveyor device 100. The host controller 40 controls power supplied to the stator 11 to control movement of the slider 30. The host controller 40 also controls driving of the movement mechanisms of the transfer conveyors 3 and 4 to control movement of the transport mechanisms 20. The host controller 40 includes a central processing unit (CPU), a memory, etc.

### Coil Control

As shown in FIG. 3, the linear conveyor modules 10 each include a plurality of control drivers 15. The plurality of control drivers 15 control a current in the plurality of coils 111 based on control signals from the host controller 40. Each of the plurality of control drivers 15 includes a circuit to control the current.

Each of the plurality of control drivers 15 is electrically connected to a controlled coil 112, which includes coils to be controlled by that control driver 15 among the plurality of coils 111. Each of the plurality of control drivers 15 applies a propulsive force along the X direction to the mover 32 by controlling a current in the controlled coil 112. Each of the plurality of control drivers 15 acquires a current command for the controlled coil 112 based on control signals (position command and speed command) from the host controller 40, and controls the current in the controlled coil 112 based on the acquired current command.

In this embodiment, the controlled coil 112 includes a plurality of (two) sets of three-phase coils. That is, the controlled coil 112 includes six coils 111 including two U-phase coils 111, two V-phase coils 111, and two W-phase coils 111. The plurality of sets of three-phase coils of the controlled coil 112 are connected in series with each other.

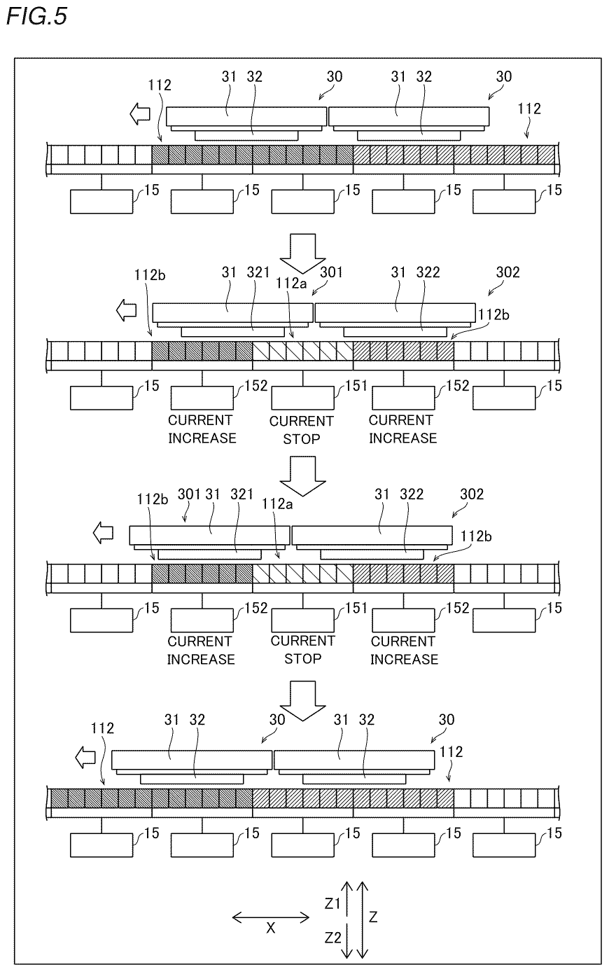

A propulsive force reduction control according to this embodiment is now described with reference to FIG. 4. In the following, the control driver 15 that performs the propulsive force reduction control is called a first control driver 151. The controlled coil 112 connected to the first control driver 151 is called a first controlled coil 112a. One of two sliders 30 is called a first slider 301, and the other is called a second slider 302. The mover 32 of the first slider 301 is called a first mover 321, and the mover 32 of the second slider 302 is called a second mover 322. The controlled coil 112 adjacent to the first controlled coil 112a is called a second controlled coil 112b, and the control driver 15 connected to the second controlled coil 112b is called a second control driver 152.

As shown in FIG. 4, in this embodiment, the first control driver 151 of the plurality of control drivers 15 performs the propulsive force reduction control to control a current in the first controlled coil 112a so as to reduce a propulsive force that the first controlled coil 112a applies to the first mover 321 and the second mover 322 when both the first mover 321 and the second mover 322 are located above the first controlled coil 112a to which that first control driver 151 is connected. Specifically, when both the first mover 321 and the second mover 322 are located above the first controlled coil 112a, the first control driver 151 performs the propulsive force reduction control so as not to flow a current to the first controlled coil 112a. At this time, it is possible to bring the first slider 301 (first mover 321) and the second slider 302 (second mover 322) closer to each other until a pitch P between the sliders 30 (between the first slider 301 and the second slider 302) becomes minimum. The minimum pitch P is a distance between the centers of the first slider 301 and the second slider 302 when the first slider 301 and the second slider 302 are closest to each other. The minimum pitch P is a value at which a distance D between the end faces of the first mover 321 and the second mover 322 is less than the length L1 of the first controlled coil 112a.

In this embodiment, the first control driver 151 performs the propulsive force reduction control when the magnetic sensor 12 detects that both the first mover 321 and the second mover 322 are located above the first controlled coil 112a. In this embodiment, the first control driver 151 performs the propulsive force reduction control when both the first mover 321 and the second mover 322 are located above the first controlled coil 112a including a plurality of sets of three-phase coils.

In this embodiment, when the first control driver 151 performs the propulsive force reduction control, the second control driver 152 connected to the second controlled coil 112b adjacent to the first controlled coil 112a performs a control to increase a current in the second controlled coil 112b so as to compensate for a reduction in a propulsive force of a controlled mover that is either the first mover 321 or the second mover 322 and is located above the second controlled coil 112b to which that second control driver 152 is connected, caused by the propulsive force reduction control. Specifically, when the first control driver 151 performs the propulsive force reduction control, the second control driver 152 performs a control to increase the current in the second controlled coil 112b so as to maintain the propulsive force of the controlled mover by compensating for the reduction in the propulsive force of the controlled mover caused by the propulsive force reduction control.

In this embodiment, the second control driver 152 performs a control to increase the current in the second controlled coil 112b based on an overlap amount A between the controlled mover and the first controlled coil 112a so as to compensate for the reduction in the propulsive force of the controlled mover caused by the propulsive force reduction control. Specifically, the second control driver 152 acquires a current command magnification for the second controlled coil 112b based on the overlap amount A, and performs a control to increase the current in the second controlled coil 112b based on the acquired current command magnification for the second controlled coil 112b so as to compensate for the reduction in the propulsive force of the controlled mover caused by the propulsive force reduction control. At this time, this second control driver 152 acquires the current command magnification for the second controlled coil 112b so as to maintain the propulsive force of the first mover 321 by the following formula (1):

$$MA = \{ ( A / L 2 ) \times 2 + 1 \} \qquad ( 1 )$$

where MA represents the current command magnification, A represents the overlap amount between the controlled mover and the first controlled coil 112a, and L2 represents the total length of the mover 32.

For example, the second control driver 152 (the second control driver 152 on the left side of FIG. 4) that controls the first mover 321 as the controlled mover acquires the overlap amount A between the first mover 321 as the controlled mover and the first controlled coil 112a based on the position information of the first mover 321 detected by the magnetic sensors 12, and acquires the current command magnification for the second controlled coil 112b to which that second control driver 152 is connected based on the acquired overlap amount A. At this time, this second control driver 152 acquires the current command magnification for the second controlled coil 112b so as to maintain the propulsive force of the first mover 321 by the above formula (1). In addition, this second control driver 152 performs a control to increase the current in the second controlled coil 112b based on a current command increased by the acquired current command magnification. Thus, the propulsive force of the first mover 321 is maintained.

As a specific example, when the overlap amount A is 10 mm and the total length L2 of the mover 32 (first mover 321) is 100 mm, the current command magnification is 1.2. In acquiring the current command magnification, adjustment may be made based on the electrical angles of the three-phase coils.

For example, the second control driver 152 (the second control driver 152 on the right side of FIG. 4) that controls the second mover 322 as the controlled mover acquires the overlap amount A between the second mover 322 as the controlled mover and the first controlled coil 112a based on the position information of the second mover 322 detected by the magnetic sensors 12, and acquires the current command magnification for the second controlled coil 112b to which that second control driver 152 is connected based on the acquired overlap amount A. At this time, this second control driver 152 acquires the current command magnification for the second controlled coil 112b so as to maintain the propulsive force of the second mover 322 by the above formula (1). In addition, this second control driver 152 performs a control to increase the current in the second controlled coil 112b based on a current command increased by the acquired current command magnification. Thus, the propulsive force of the second mover 322 is maintained.

As a specific example, when the overlap amount A is 30 mm and the total length L2 of the mover 32 (first mover 321) is 100 mm, the current command magnification is 1.6. In acquiring the current command magnification, adjustment may be made based on the electrical angles of the three-phase coils.

An example of the operation of the sliders 30 involving the propulsive force reduction control is now described with reference to FIG. 5. Here, an example of the operation in which the two sliders 30 move in the same direction with the minimum pitch P is described.

As shown in FIG. 5, when only one mover 32 is located above the controlled coil 112, a normal slider control is performed. That is, the current in the controlled coil 112 is controlled by a 1× current command.

Then, when the two movers 32 (first mover 321 and second mover 322) come to be located above the controlled coil 112 (first controlled coil 112a), the propulsive force reduction control is performed. That is, the current in the first controlled coil 112a is controlled by the first control driver 151 connected to the first controlled coil 112a so as to reduce the propulsive force that the first controlled coil 112a applies to the first mover 321 and the second mover 322. Specifically, the first control driver 151 controls the current in the first controlled coil 112a so as not to flow a current to the first controlled coil 112a.

The second control driver 152 connected to the second controlled coil 112b adjacent to the first controlled coil 112a performs a control to increase the current in the second controlled coil 112b so as to compensate for the reduction in the propulsive force caused by the propulsive force reduction control of the controlled mover located above the second controlled coil 112b to which that second control driver 152 is connected. Specifically, the second control driver 152 acquires the overlap amount A between the controlled mover and the first controlled coil 112a, and acquires the current command magnification for the second controlled coil 112b based on the acquired overlap amount A. At this time, the overlap amount A that changes in response to movement of the first mover 321 and the second mover 322 is sequentially acquired, and the current command magnification for the second controlled coil 112b is sequentially acquired. Therefore, the amount of increase in the current in the second controlled coil 112b changes in response to movement of the first mover 321 and the second mover 322. For example, in the second controlled coil 112b on the left side of FIG. 5, the overlap amount A gradually decreases in response to movement of the first mover 321, and thus the current command magnification for the second controlled coil 112b gradually decreases, and the amount of increase in the current in the second controlled coil 112b gradually decreases. Furthermore, for example, in the second controlled coil 112b on the right side of FIG. 5, the overlap amount A gradually increases in response to movement of the second mover 322, and thus the current command magnification for the second controlled coil 112b gradually increases, and the amount of increase in the current in the second controlled coil 112b gradually increases.

Then, when only one mover 32 comes to be located above the controlled coil 112, the normal slider control is performed. That is, the current in the controlled coil 112 is controlled by a 1× current command. Such a control is performed along with the operation of the sliders 30 involving the propulsive force reduction control.

Although the example of the operation in which the two sliders 30 move in the same direction with the minimum pitch P has been described, the operation of the sliders 30 involving the propulsive force reduction control is not limited to this. For example, even in the case of the operation in which the two sliders 30 move in opposite directions from the state of the minimum pitch P, the operation of the sliders 30 involving the propulsive force reduction control is performed. Furthermore, in the case of the operation in which one slider 30 approaches the other slider 30 such that the two sliders 30 have the minimum pitch P, the operation of the sliders 30 involving the propulsive force reduction control is performed. Even when the two sliders 30 do not reach the minimum pitch P, the operation of the sliders 30 involving the propulsive force reduction control is performed when the two movers 32 are located above one controlled coil 112.

### Control Process Related to Control of Sliders

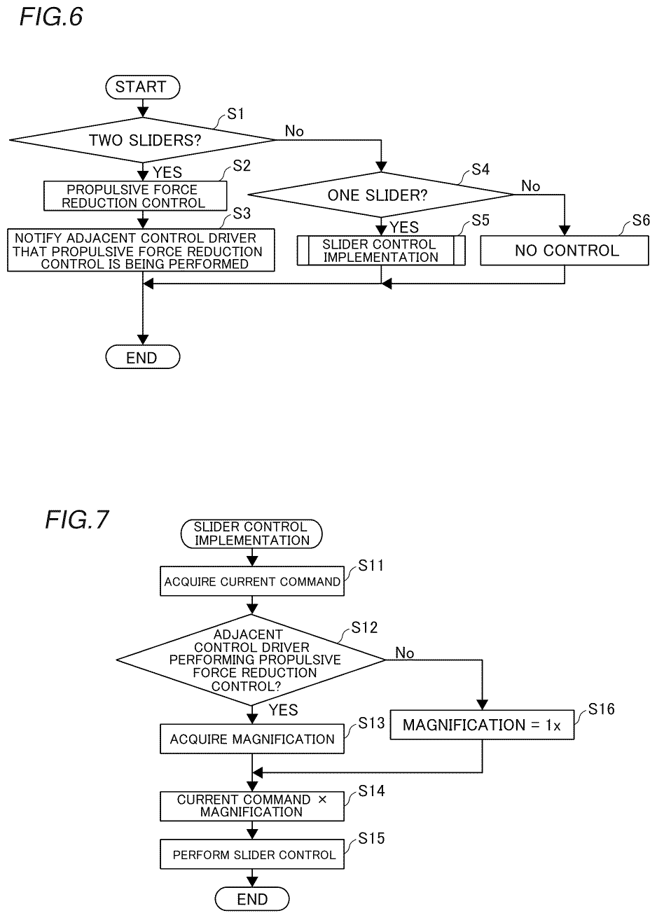

A control process related to the control of the sliders 30 is now described based on a flowchart with reference to FIGS. 6 and 7. Each process operation in the flowchart is performed by the control driver 15.

As shown in FIG. 6, first, in step S1, it is determined whether or not the two sliders 30 (movers 32) are located above the controlled coil 112 to which that control driver 15 is connected. When it is determined that the two sliders 30 (movers 32) are located above the controlled coil 112 to which that control driver 15 is connected, the process advances to step S2. Then, in step S2, the propulsive force reduction control is performed. Then, in step S3, the adjacent control driver 15 (second control driver 152) is notified that the propulsive force reduction control is being performed. In step S2 and step S3, the control driver 15 functions as the first control driver 151.

When it is determined in step S2 that neither of the two sliders 30 (movers 32) is located above the controlled coil 112 to which that control driver 15 is connected, the process advances to step S4. Then, in step S4, it is determined whether or not one of the sliders 30 (movers 32) is located above the controlled coil 112 to which that control driver 15 is connected. When it is determined that one of the sliders 30 (movers 32) is located above the controlled coil 112 to which that control driver 15 is connected, the process advances to step S5. Then, in step S5, the slider control is performed. The slider control is described below in detail.

When it is determined in step S4 that one of the sliders 30 (movers 32) is not located above the controlled coil 112 to which that control driver 15 is connected, the process advances to step S6. Then, in step S6, it is determined that the slider control is not to be performed.

The slider control in step S5 is now described in detail with reference to FIG. 7.

As shown in FIG. 7, first, in step S11, a current command for the controlled coil 112 is acquired. Then, in step S12, it is determined whether or not the adjacent control driver 15 is performing the propulsive force reduction control. When it is determined that the adjacent control driver 15 is performing the propulsive force reduction control, the process advances to step S13. Then, in step S13, a current command magnification that is greater than 1× is acquired based on the overlap amount A. When step S13 is passed, in step S14, the current command is multiplied by the magnification that is greater than 1×, and in step S15, the slider control is performed based on the current command multiplied by the magnification that is greater than 1×. In step S13, step S14, and step S15, the control driver 15 functions as the second control driver 152.

When it is determined in step S12 that the adjacent control driver 15 is not performing the propulsive force reduction control, the process advances to step S16. Then, in step S16, a current command magnification of 1× is acquired. When step S16 is passed, in step S14, the current command is multiplied by the magnification of 1×, and in step S15, the slider control (normal slider control) is performed based on the current command multiplied by the magnification of 1×.

According to this embodiment, the following advantageous effects are achieved.

According to this embodiment, as described above, the first control driver 151 is configured to, when both the first mover 321 and the second mover 322 are located above the first controlled coil 112a to which that first control driver 151 is connected, perform the propulsive force reduction control to control the current in the first controlled coil 112a so as to reduce the propulsive force that the first controlled coil 112a applies to the first mover 321 and the second mover 322. Accordingly, even when both the first mover 321 and the second mover 322 are located above the first controlled coil 112a, the influence of the first controlled coil 112a can be reduced, and thus the first mover 321 and the second mover 322 can approach each other to a distance less than the length L1 of the first controlled coil 112a. Consequently, the minimum pitch P between the sliders 30 (between the first slider 301 and the second slider 302) can be reduced.

In addition, the minimum pitch P between the sliders 30 is reduced such that the space efficiency can be improved. For example, due to the large minimum pitch P between the sliders 30, adjacent processes cannot be arranged close to each other, and a distance between the processes may become large. In contrast, the minimum pitch P between the sliders 30 is reduced such that adjacent processes can be arranged close to each other, and a distance between the processes can become small. Moreover, for example, due to the large minimum pitch P between the sliders 30, the sliders 30 waiting for work cannot be arranged close to each other, and a waiting space for the sliders 30 may become large. In contrast, the minimum pitch P between the sliders 30 is reduced such that the sliders 30 waiting for work can be arranged close to each other, and a waiting space for the sliders 30 can become small. Furthermore, the space efficiency is improved such that the compact linear conveyor device 100 can be achieved.

According to this embodiment, as described above, the first control driver 151 is configured to, when both the first mover 321 and the second mover 322 are located above the first controlled coil 112a, perform the propulsive force reduction control so as not to flow a current to the first controlled coil 112a. Accordingly, even when both the first mover 321 and the second mover 322 are located above the first controlled coil 112a, the influence of the first controlled coil 112a can be easily reduced, and thus the minimum pitch P between the sliders 30 (between the first slider 301 and the second slider 302) can be easily reduced.

According to this embodiment, as described above, the second control driver 152 connected to the second controlled coil 112b adjacent to the first controlled coil 112a is configured to, when the first control driver 151 performs the propulsive force reduction control, perform a control to increase the current in the second controlled coil 112b so as to compensate for the reduction in the propulsive force of the controlled mover that is either the first mover 321 or the second mover 322 and is located above the second controlled coil 112b, caused by the propulsive force reduction control. Accordingly, the reduction in the propulsive force caused by the propulsive force reduction control can be compensated for, and thus a decrease in the transport speeds of the first slider 301 and the second slider 302 can be reduced or prevented. Consequently, an increase in the transport time of the first slider 301 and the second slider 302 can be reduced or prevented.

According to this embodiment, as described above, the second control driver 152 is configured to, when the first control driver 151 performs the propulsive force reduction control, perform a control to increase the current in the second controlled coil 112b so as to maintain the propulsive force by compensating for the reduction in the propulsive force of the controlled mover caused by the propulsive force reduction control. Accordingly, the reduction in the propulsive force caused by the propulsive force reduction control can be compensated for to maintain the propulsive force, and thus a decrease in the transport speeds of the first slider 301 and the second slider 302 can be easily reduced or prevented. Consequently, an increase in the transport time of the first slider 301 and the second slider 302 can be easily reduced or prevented.

According to this embodiment, as described above, the second control driver 152 is configured to perform a control to increase the current in the second controlled coil 112b so as to compensate for the reduction in the propulsive force of the controlled mover caused by the propulsive force reduction control, based on the overlap amount A between the controlled mover and the first controlled coil 112a. Accordingly, the current in the second controlled coil 112b can be increased based on the overlap amount A between the controlled mover and the first controlled coil 112a, which correlates with the reduction in the propulsive force caused by the propulsive force reduction control, and thus the reduction in the propulsive force caused by the propulsive force reduction control can be accurately compensated for.

According to this embodiment, as described above, the second control driver 152 is configured to acquire the current command magnification for the second controlled coil 112b based on the overlap amount A, and perform a control to increase the current in the second controlled coil 112b based on the acquired current command magnification for the second controlled coil 112b so as to compensate for the reduction in the propulsive force of the controlled mover caused by the propulsive force reduction control. Accordingly, the current in the second controlled coil 112b can be increased based on the current command magnification acquired based on the overlap amount A, and thus the reduction in the propulsive force caused by the propulsive force reduction control can be easily and accurately compensated for.

According to this embodiment, as described above, the linear conveyor device 100 further includes the magnetic sensors 12 to detect the positions of the first mover 321 and the second mover 322, and the first control driver 151 is configured to perform the propulsive force reduction control when the magnetic sensors 12 detect that both the first mover 321 and the second mover 322 are located above the first controlled coil 112a. Accordingly, the propulsive force reduction control can be performed in a state in which the magnetic sensors 12 reliably detect that both the first mover 321 and the second mover 322 are located above the first controlled coil 112a.

According to this embodiment, as described above, the controlled coil 112 includes the plurality of sets of three-phase coils, and the first control driver 151 is configured to perform the propulsive force reduction control when both the first mover 321 and the second mover 322 are located above the first controlled coil 112a including the plurality of sets of three-phase coils. Accordingly, when the controlled coil including the plurality of sets of three-phase coils, which tends to increase the minimum pitch P between the sliders 30 (between the first slider 301 and the second slider 302) due to its large length, is used, the minimum pitch P between the sliders 30 can be effectively reduced.

### Modified Examples

The embodiment disclosed this time must be considered as illustrative in all points and not restrictive. The scope of the present disclosure is not shown by the above description of the embodiment but by the scope of claims for patent, and all modifications (modified examples) within the meaning and scope equivalent to the scope of claims for patent are further included.

For example, while the example in which the propulsive force reduction control is performed such that a current does not flow to the first controlled coil has been shown in the aforementioned embodiment, the present disclosure is not restricted to this. For example, as long as the propulsive force that the first controlled coil applies to the first mover and the second mover are reduced, the propulsive force reduction control may be performed such that a current flows to the first controlled coil.

While the example in which the current in the second controlled coil is increased so as to maintain the propulsive force by compensating for the reduction in the propulsive force of the controlled mover caused by the propulsive force reduction control has been shown in the aforementioned embodiment, the present disclosure is not restricted to this. For example, as long as the reduction in the propulsive force of the controlled mover caused by the propulsive force reduction control is compensated for, the current in the second controlled coil may be increased by the amount of increase smaller than that required to maintain the propulsive force.

While the example in which the magnetic sensors are provided as position detectors has been shown in the aforementioned embodiment, the present disclosure is not restricted to this. For example, devices other than the magnetic sensors may be provided as position detectors.

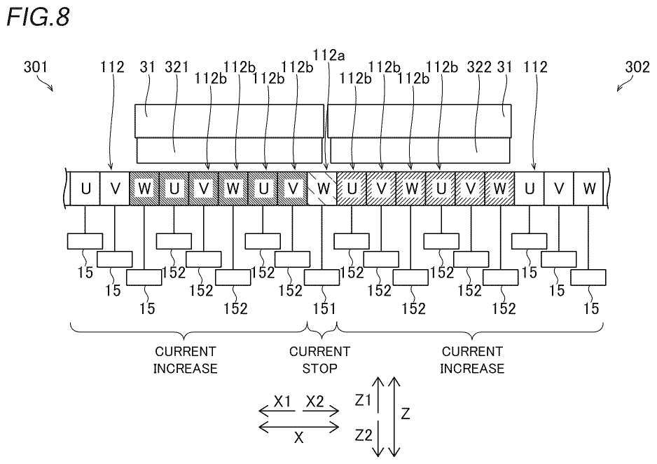

While the example in which the controlled coil includes two sets of three-phase coils has been shown in the aforementioned embodiment, the present disclosure is not restricted to this. For example, the controlled coil may include one set or three or more sets of three-phase coils. Alternatively, as in a modified example shown in FIG. 8, the controlled coil 112 may include one coil of a set of three-phase coils. In such a case, the first control driver 151 performs the propulsive force reduction control when both the first mover 321 and the second mover 322 are located above the first controlled coil 112a including one coil of a set of three-phase coils. Accordingly, when the controlled coil 112 including one coil of the set of three-phase coils, which tends to reduce the minimum pitch P between the sliders 30 (between the first slider 301 and the second slider 302) due to its small length, is used, the minimum pitch P between the sliders 30 can be further reduced.

While the example in which the first control driver performs the propulsive force reduction control regardless of the overlap amount between the first controlled coil and the first mover or the second mover when both the first mover and the second mover are located above the first controlled coil to which that first control driver is connected has been shown in the aforementioned embodiment, the present disclosure is not restricted to this. For example, the first control driver may be configured to perform the propulsive force reduction control when the overlap amount between the first controlled coil to which that first control driver is connected and the first mover or the second mover is larger than a predetermined value.

While the example in which the second control driver performs a control to increase the current in the second controlled coil based on the overlap amount between the controlled mover and the first controlled coil has been shown in the aforementioned embodiment, the present disclosure is not restricted to this. For example, in the case of the operation in which the first slider approaches the second slider, the second control driver corresponding to the first slider may perform a control to increase the current in the second controlled coil by an amount greater than the amount of increase based on the overlap amount between the controlled mover and the first controlled coil. Alternatively, the second control driver corresponding to the second slider may perform a control to increase the current in the second controlled coil by an amount smaller than the amount of increase based on the overlap amount between the controlled mover and the first controlled coil. Accordingly, in the case of the operation in which the first slider approaches the second slider, the risk of interference between the first slider and the second slider can be reduced.

While the control process is described, using the flowchart described in a manner driven by a flow in which processes are performed in order along a process flow for the convenience of illustration in the aforementioned embodiment, the present disclosure is not restricted to this. In the present disclosure, the control process may be performed in an event-driven manner in which processes are performed on an event basis. In this case, the control process may be performed in a complete event-driven manner or in a combination of an event-driven manner and a manner driven by a flow.

What is claimed is:

1. A linear conveyor device comprising:
a first slider including a first mover;
a second slider including a second mover;
a stator including a plurality of coils arranged along a predetermined direction; and
a plurality of control drivers each connected to a controlled coil among the plurality of coils to control a current in the controlled coil to which that control driver is connected to apply a propulsive force along the predetermined direction to the first mover and the second mover; wherein
a first control driver of the plurality of control drivers is configured to, when both the first mover and the second mover are above a first controlled coil to which that first control driver is connected, perform a propulsive force reduction control to control a current in the first controlled coil so as to reduce the propulsive force that the first controlled coil applies to the first mover and the second mover.

2. The linear conveyor device according to claim 1, wherein the first control driver is configured to, when both the first mover and the second mover are above the first controlled coil, perform the propulsive force reduction control so as not to flow a current to the first controlled coil.

3. The linear conveyor device according to claim 1, wherein a second control driver connected to a second controlled coil adjacent to the first controlled coil is configured to, when the first control driver performs the propulsive force reduction control, perform a control to increase a current in the second controlled coil so as to compensate for a reduction in the propulsive force of a controlled mover that is either the first mover or the second mover and is above the second controlled coil, caused by the propulsive force reduction control.

4. The linear conveyor device according to claim 3, wherein the second control driver is configured to, when the first control driver performs the propulsive force reduction control, perform a control to increase the current in the second controlled coil so as to maintain the propulsive force by compensating for the reduction in the propulsive force of the controlled mover caused by the propulsive force reduction control.

5. The linear conveyor device according to claim 3, wherein the second control driver is configured to perform a control to increase the current in the second controlled coil so as to compensate for the reduction in the propulsive force of the controlled mover caused by the propulsive force reduction control, based on an overlap amount between the controlled mover and the first controlled coil.

6. The linear conveyor device according to claim 5, wherein the second control driver is configured to acquire a current command magnification for the second controlled coil based on the overlap amount, and perform a control to increase the current in the second controlled coil based on an acquired current command magnification for the second controlled coil so as to compensate for the reduction in the propulsive force of the controlled mover caused by the propulsive force reduction control.

7. The linear conveyor device according to claim 1, further comprising:
a position detector configured to detect positions of the first mover and the second mover; wherein
the first control driver is configured to perform the propulsive force reduction control when the position detector detects that both the first mover and the second mover are above the first controlled coil.

8. The linear conveyor device according to claim 1, wherein
the controlled coil includes one set or a plurality of sets of three-phase coils; and
the first control driver is configured to perform the propulsive force reduction control when both the first mover and the second mover are above the first controlled coil including the one set or the plurality of sets of three-phase coils.

9. The linear conveyor device according to claim 1, wherein
the controlled coil includes one coil of a set of three-phase coils; and
the first control driver is configured to perform the propulsive force reduction control when both the first mover and the second mover are above the first controlled coil including the one coil of the set of three-phase coils.

10. A method for controlling a linear conveyor device, the linear conveyor device including a first slider including a first mover, a second slider including a second mover, a stator including a plurality of coils arranged along a predetermined direction, the method comprising:
controlling a current in the plurality of coils to apply a propulsive force along the predetermined direction to the first mover and the second mover; and
performing a propulsive force reduction control to control a current in a predetermined controlled coil of the plurality of coils so as to reduce the propulsive force that the predetermined controlled coil applies to the first mover and the second mover when both the first mover and the second mover are above the predetermined controlled coil.
